(19) United States
(12) Patent Application Publication
(10) Pub. No.: US 2007/0177390 A1
(43) Pub. Date: Aug. 2, 2007

(54) Hanging lighting fixture for retrofitting to recessed ceiling lights

(76) Inventor: Mary Ann Evans, Downers Grove, IL (US)

Correspondence Address: BRIAN R. RAYVE, 161 MAPLE DRIVE, PARK CITY, UT, 84098, US

(21) Appl. No.: 11/342,714

(22) Filed: Jan. 30, 2006

(51) Int. Cl. F21V 15/00

(52) U.S. Cl. 362/365; 362/147

(57) ABSTRACT

A hanging lighting fixture that is easily and quickly changed over from a recessed ceiling light without requiring rewiring. The lighting fixture utilizes a housing with attached light bulb socket of the ceiling light already affixed within a hole in a ceiling. The lighting fixture includes a cover plate that mounts to the ceiling covering the housing and the hole to provide a finished look. A screw plug threadably engages the light bulb socket that is electrically connected to a light bulb socket through an electrical cord that includes a pair of insulated electrical wires. The electrical cord has a top end extending through a cord mounting hole of the cover plate connected to the screw plug supported by the cover plate using a cord coupling. A bottom end of the electrical cord is connected to the light bulb socket extending through a heat shield in which the light bulb socket is mounted. A lamp shade is connected to the light bulb socket. The cover plate mounts to the ceiling using screws that extend through respective ceiling mounting holes thereof into screw anchors press-fit into respective bores of the ceiling. The screw plug may connect to the housing for electrical grounding and the light bulb socket may be electrically grounded thereto through a ground conductor. The ground conductor is part of the electrical cord with a lower end connected to the light bulb socket and an upper end that extends outwardly from the screw plug. The upper end terminates at an electrically conductive, finger-operable spring clamp for gripping the housing that requires no installation tools.

### BACKGROUND OF THE INVENTION

1. Field

The present invention relates generally relates to indoor lighting fixtures which mount to a ceiling of a building structure to provide indoors illumination, and more particularly to hanging lighting fixtures which include one or more light bulbs disposed in sockets which hang downwardly from a cover plate connected covering the electrical box on respective power cords to place the indoors illumination closer to eye level such as over a desk, a dinner table, or other furniture.

2. State of the Art

Recessed ceiling lights have been used in houses and other building structures for many years to provide functional, downwardly directed spot lighting. They provide concentrated lighting for various lighting effects, to strongly illuminate areas that need extra lighting such as reading areas, and the like. Recessed ceiling lights include an electrically grounded can or housing, typically of a cylindrical cup-shaped configuration, affixed within a hole in a ceiling of the building structure. The housing has a light bulb socket mounted therein for threadably receiving a spotlight. The light bulb socket is connected to an electrical system of the building structure to provide indoors illumination to a room of the building structure. The recessed ceiling light has a support ring which connects to the housing to support a circular transparent lens to the housing through which light from the spotlight is directed. Both are easily removable from the housing to replace the spotlight when it burns out.

Pendent or hanging lighting fixtures have also been used in houses and other building structures for many years to provide decorative lighting. They provide more diffuse, lower level lighting for more decorative room areas such as over dinner tables, counter tops, and the like. Hanging lighting fixtures are mounted to a conventional electrically grounded electrical box of circular, rectangular, or hexagonal cup-shaped configuration affixed within a hole cut into the ceiling of the building structure.

The hanging lighting fixture typically includes a decoratively formed cover plate to cover the hole and electrical box, and one or more light assemblies. The cover plate may be of any shape to fit the electrical box and hole. The cover plate has a center hole and a cord mounting hole for each light assembly at which they attach. The cover plate mounts to the electrical box using an externally threaded center tube that extends through the center hole of the cover plate. The center tube has an upper end that threads into a transverse mounting plate attached to the electrical box. The center tube has a lower end with a decorative nut threaded thereon to retain the cover plate to the electrical box. Each light assembly includes an electrical cord having a top end hand-wired to the electrical system of the building structure using a plurality of electrical connectors and connected extending through the cord mounting hole of the cover plate using a cord coupling. The electrical cord has a bottom end with an attached light socket assembly for receiving a light bulb. A lamp shade is removably connected to the light socket assembly. The cord coupling may allow height adjustment of the light socket assembly and the lamp shade.

The recessed ceiling lights and hanging lighting fixtures are adequate for the purposes intended. Each typically requires professional initial installation including: 1) cutting the holes in the ceiling in a location adjacent a floor or ceiling stud for mounting of the electrical box or housing; 2) routing of electrical wiring of the electrical system into the electrical box or housing; 3) hand-wiring of a ground wire of the electrical wiring of the electrical system to the electrical box or housing for electrical grounding purposes typically using a ground screw that threads into the electrical box or housing to prevent electrical shocking of users; 4) hand-wiring of the recessed ceiling light or hanging lighting fixture to the electrical wiring of the electrical system by stripping individual insulated wires and connecting together proper pairs thereof using individual screw-type electrical connectors; 5) connecting a ground wire of the recessed ceiling light or hanging lighting fixture to the ground screw to provide grounding thereto; and 6) mounting the cover plate to the recessed ceiling light or hanging lighting fixture.

While professional installation of the recessed ceiling light or hanging lighting fixture is typically fine for initial installation since professionals are typically used to build the house or other building structure in the first place, retrofit or changeover of an installed recessed ceiling light to a hanging lighting fixture is a different story. A homeowner may decide that he or she wants to change (such as during home remodeling) the functional concentrated light of the recessed ceiling light to the decorative light of the hanging lighting fixture. This typically must be done by hiring a professional to do the hand-rewiring or risk doing so improperly causing a risk of personal injury or death to the homeowner during installation due to crossing wires, presenting a later risk of electrical shock due to improper grounding, or presenting a risk of immediate or later fire due to both.

Likewise, changing over of the recessed ceiling light to the hanging lighting fixture has several other serious shortcomings. These include: 1) causing ceiling damage that must be repaired by re-spackling and repainting; 2) lengthy installation time to hand-wire the hanging lighting fixture to the electrical system of the building structure; 3) the cover plate of the hanging lighting fixture typically is too small to hide the previous holes made in the ceiling to mount the recessed ceiling light; 4) remodeling is difficult since a professional typically must be found and scheduled to do the work; 5) the recessed ceiling light is not easily replaced if damaged, bums out, or if a different style is desired; and 6) costs money for professional installation including proper hand-wiring and repair to the ceiling.

Various electrical connectors or screw plugs have been developed to allow a conventional two-pronged electrical plug of a power cord for plugging into two and three prong electrical wall outlets to plug-into a light bulb socket of a lighting fixture to electrically power other lighting fixtures, appliances, and the like. These connectors are typically fairly complex in design having many component parts and are well-known so specific details will not be discussed. In general, the connectors have a cylindrical insulating body comprised of a variety of component parts. An electrically conductive outer jacket is affixed about the body of mating externally threaded configuration to threadably engage light bulb sockets. An electrically conductive center post extends longitudinally from the body coaxially with the outer jacket. A two-prong electrical socket is built into the body opposite the center post to which the electrical plug of the power cord connects.

The electrical connectors have several serious shortcomings. Firstly, they do not accommodate electrical grounding for using three prong electrical cords. Secondly, they do not come in versions with a dependent electrical cord to directly power other lighting fixtures or electrical devices that are directly wired to an electrical cord rather than having a dependent power cord that terminates at an electrical plug for plugging into the wall socket. Thirdly, they are of rather complex design and thus is inherently less reliable and is expensive to manufacture and sell.

There is a need for a ceiling light in the form of a hanging lighting fixture and a method of installation thereof that solves the problems encountered in changing over the recessed ceiling light to a hanging lighting fixture, including: 1) causing minimal or no ceiling damage eliminating the need for re-spackling and repainting; 2) requiring minimal installation time with no hand-wiring of the hanging lighting fixture to the electrical system of the building structure; 3) the cover plate of the hanging lighting fixture is large enough to hide the previous holes made in the ceiling to mount the recessed ceiling light; 4) remodeling is easily done when desired by the homeowner not requiring the professional to do the work; 5) the hanging lighting fixture is easily replaced if damaged, burns out, or if a different style is desired; and 6) costing no money for professional installation.

Additionally, there is a need for an electrical connector for use in the hanging lighting fixture that solves the problems encountered in wiring thereof to the electrical system of the building structure including: 1) accommodating electrical grounding of the hanging lighting fixture; 2) having a dependent electrical cord to directly power the hanging lighting fixture; and 3) being of simple design that is reliable and is inexpensive to manufacture and sell.

### SUMMARY OF THE INVENTION

The present invention is a hanging lighting fixture for mounting to an electrically grounded housing of a recessed ceiling light affixed within a hole in a ceiling to a building structure with an attached light bulb socket electrically connected to a building electrical system for threadably receiving a light bulb, a screw plug for electrically powering the hanging lighting fixture changed over from the recessed ceiling light without requiring rewiring, and a method of changing over the recessed ceiling light to the hanging lighting fixture without necessitating rewiring.

The hanging lighting fixture includes a cover plate adapted to mount to at least one of the ceiling and the housing. The cover plate is of a size and shape sufficient to completely cover the housing and the hole to provide a finished look thereto. A screw plug is adapted to threadably engage the light bulb socket of the recessed ceiling light which is electrically connected to the light bulb socket of the hanging lighting fixture through a pair of electrical conductors. At least one light bulb socket of the hanging lighting fixture is adapted for threadably receiving the light bulb and connecting to the cover plate. The hanging lighting fixture allows easy and quick changeover of the recessed ceiling light to the hanging lighting fixture without rewiring. This is done by screwing the screw plug into the bulb socket of the recessed ceiling light and mounting the cover plate to the at least one of the ceiling and the housing.

In a preferred hanging lighting fixture, the light bulb socket of the hanging lighting fixture is part of a light assembly which includes an electrical cord having the electrical conductors which comprise respective insulated electrical wires. The electrical cord has a top end which extends through a cord mounting hole of the cover plate that is electrically connected to the screw plug and mechanically connected to the cover plate using a cord coupling. The electrical cord has a bottom end that is electrically and mechanically connected to the light bulb socket of the hanging lighting fixture. The bottom end of the electrical cord passes through a heat shield that is mechanically connected thereto in which the light bulb socket is mounted. A lamp shade is operatively connectable to the bottom end of the electrical cord. The cover plate mounts to the ceiling using two or more screws that extend through respective ceiling mounting holes thereof. The ceiling mounting holes are disposed radially outwardly of the hole in the ceiling. The screws extend into respective screw anchors press-fit into respective bores of the ceiling.

The screw plug includes an insulating body. An electrically conductive outer jacket of mating externally threaded configuration to the light bulb socket is affixed about the body. An electrically conductive center post extends longitudinally from the body coaxially with the outer jacket. Each of the outer jacket and the center post is electrically connected to the hanging lighting fixture through respective electrical conductors.

The screw plug is preferably adapted to connect to the housing of the recessed ceiling light for electrical grounding and the light bulb socket is electrically grounded to the screw plug through a ground conductor. The ground conductor extends outwardly from the screw plug terminating at an electrically conductive connecting device adapted to connect to the housing. The connecting device is preferably a finger-operable spring clamp adapted for gripping the housing that requires no installation tools.

The method of changing over a recessed ceiling light to a hanging lighting fixture includes the steps of: 1) providing a recessed ceiling light which includes an electrically grounded housing attached within a hole in a ceiling to a building structure with an attached light bulb socket electrically connected to a building electrical system for threadably receiving a light bulb; 2) providing a hanging lighting fixture which includes a cover plate of a size and shape sufficient to completely cover the housing and the hole in a mounting position to provide a finished look thereto and adapted to mount to the ceiling using at least a pair of screws that extend through respective ceiling mounting holes thereof disposed radially outwardly of the hole in the ceiling and respective screw anchors, at least one light bulb socket adapted for threadably receiving the light bulb and connected to the cover plate, and a screw plug adapted to threadably engage the light bulb socket which is electrically connected to the light bulb socket through a pair of electrical conductors; 3) drilling at least two bores into the ceiling that align with the ceiling mounting holes of the cover plate in the mounting position; 4) tapping the screw anchors into respective of the bores in the ceiling; 5) threading the screw plug into the light bulb socket; and 6) mounting cover plate to the ceiling by placing the screws through respective of the ceiling mounting holes of the cover plate and screwing them into the screw anchors.

In a preferred method, the recessed ceiling light provided includes a support ring which connects to the housing to support a transparent lens. The hanging lighting fixture provided has the cover plate adapted to mount to the ceiling using two or more screws that extend through respective ceiling mounting holes thereof and respective screw anchors. The ceiling mounting holes are disposed radially outwardly of the hole in the ceiling. A light assembly includes the light bulb socket and an electrical cord. The screw plug is electrically connected to the light bulb socket through the electrical cord which has the electrical conductors. A top end of the electrical cord that extends through a cord mounting hole of the cover plate is electrically connected to the screw plug and mechanically connected to the cover plate using an adjustable cord coupling. A bottom end of the electrical cord is electrically and mechanically connected to the light bulb socket thereof. A lamp shade is also provided. The method includes the additional steps of: 7) removing the support ring to release and remove the transparent lens from the housing of the recessed ceiling light; 8) operably connecting the lamp shade to the bottom end of the electrical cord; and 9) adjusting a hanging length of the light assembly using the cord coupling and storing an unneeded length of the electrical cord within the housing.

In the preferred method, the screw plug of the hanging lighting fixture provided may be adapted to connect to the housing for electrical grounding. In this case, the light bulb socket of the hanging lighting fixture is electrically grounded to the screw plug using a ground conductor that extends through the electrical cord and outwardly from the screw plug. The ground connector terminates at an electrically conductive, finger-operable spring clamp adapted to connect to the housing. The method includes an additional step of attaching the connecting device to the housing by squeezing and clipping the spring clamp to the housing.

### THE DRAWINGS

The best mode presently contemplated for carrying out the invention is illustrated in the accompanying drawings, in which:

FIG. 1 is an exploded perspective view of a prior art ceiling lighting fixture in the form of a hanging lighting fixture which requires hand-wiring to an electrical system of a building structure for installation, shown as connected to an electrical box mounted within a ceiling of the building structure to provide indoors illumination, and showing a mounting assembly and a pair of light assemblies thereof;

FIG. 2, a fragmentary perspective view of one light assembly and a forked installation tool to facilitate assembly and disassembly thereof;

FIG. 3, an exploded perspective view of an exemplary ceiling lighting fixture of the present invention in the form of a hanging lighting fixture which changes over a recessed ceiling light requiring no hand-wiring to the electrical system of the building structure, shown as connected to a housing of the recessed ceiling light mounted within the ceiling of the building structure, and showing a domed cover plate, a pair of light assemblies, and a screw plug thereof that replace the light assemblies, a support ring, and a circular transparent lens of the recessed ceiling light; and

FIG. 4, a perspective view of the screw plug to an enlarged scale.

### DETAILED DESCRIPTION OF THE ILLUSTRATED EMBODIMENTS

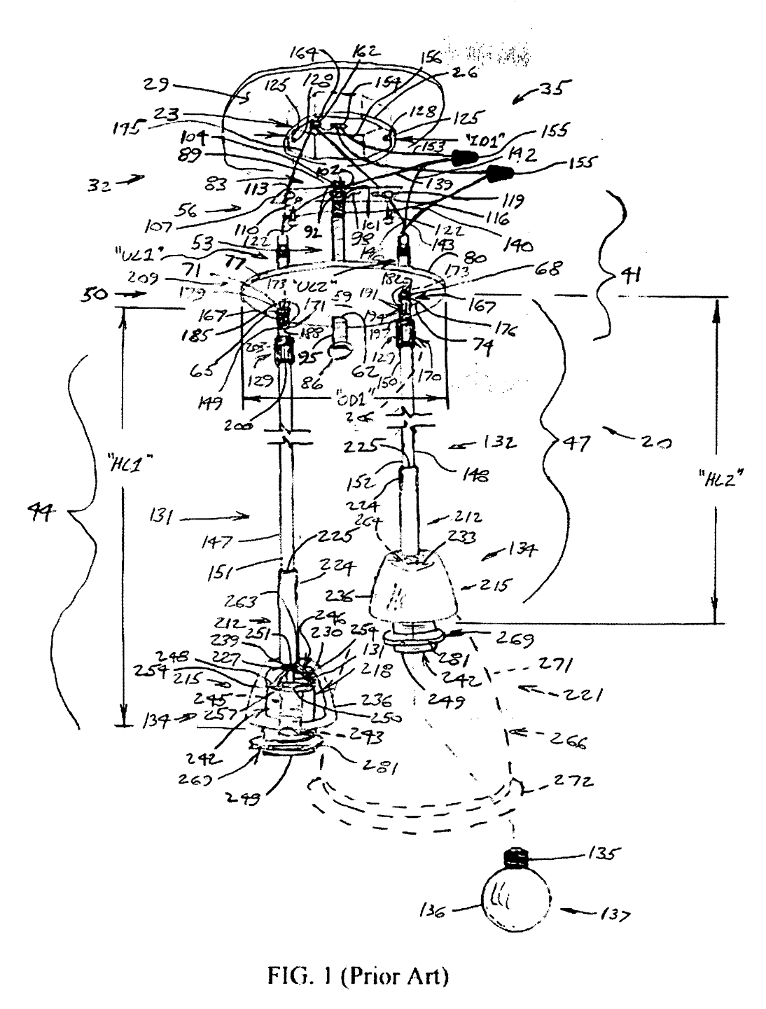

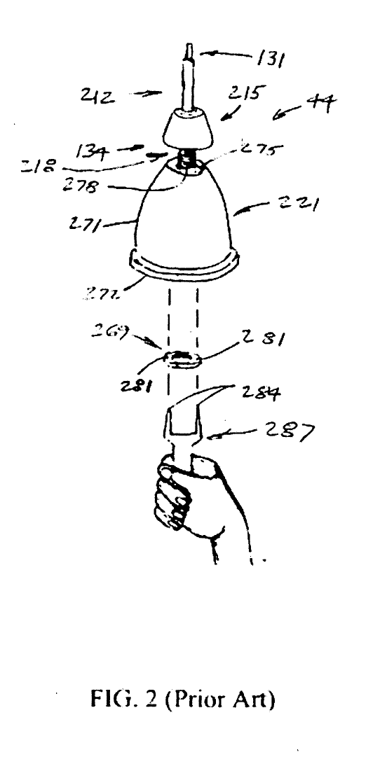

Referring to FIGS. 1 and 2, therein is shown a prior art ceiling lighting fixture in the form of a pendent or hanging lighting fixture 20 connected to a hollowed electrical box 23 of hexagonal cup-shaped configuration affixed within a hole 26 cut into a ceiling 29 to a building structure 32. The hanging lighting fixture 20 is connected to an electrical system 35 of the building structure 32. The hanging lighting fixture 20 provide indoors illumination to a room 38 of the building structure 32.

The hanging lighting fixture 20 includes a mounting assembly 41 and a pair of light assemblies 44 and 47. The mounting assembly 41 includes a domed cover plate 50, an externally threaded center tube 53, and a transverse mounting plate 56. The cover plate 50 is of circular shape to fit the electrical box 23 of the hexagonal shape and the hole 26. The cover plate 50 has a domed central area 59 with a center hole 62 disposed therethrough to receive the center tube 53. The domed central area 59 has respective cord mounting holes 65 and 68 disposed therethrough at a pair of flattened cord connecting areas 71 and 74 at which the light assemblies 44 and 47 attach as explained below. The cover plate 50 has an upwardly directed annular outer lip 77 with an annular top edge 80 adapted to engage the ceiling 29. The cover plate 50 mounts to the electrical box 23 and has an outer diameter “OD1” greater than an inner diameter “ID1” of the hole 26 in the ceiling 29 to accommodate the electrical box 23 to provide a finished look thereto. The cover plate 50 and the center tube 53 are typically suitably stamped or machined from a metal such as steel, aluminum, or brass. The cover plate 50 is typically painted to provide a nice appearance. The mounting plate 56 is typically stamped a metal such as steel and plated for corrosion resistance.

The center tube 53 is mounted to the cover plate 50 extending through the center hole 62 using a hardware assembly 83 which includes a domed finishing nut 86, a lockwasher 89, and a pair of hexagonal nuts 92. The finishing nut 86 threads onto a bottom end 95 of the center tube 53 as extending through the center hole 62 disposed directly below and engaging the cover plate 50. The lockwasher 89 is disposed immediately above the cover plate 50 on the center tube 53 with the hexagonal nuts 92 threaded onto the center tube 53 tightened against the lockwasher 89 to retain the center tube 53 extending upwardly from the cover plate 50.

The mounting plate 56 is of elongated rectangular shape including a central area 98 with a center hole 101 to receive the center tube 53 defined by an upwardly formed flange 102 that is internally threaded to threadably engage a top end 104 of the center tube 53. A first end area 107 of the mounting plate 56 has a mounting hole 110 and a transverse keyhole groove 113. A second end area 116 of the mounting plate 56 has a longitudinal keyhole groove 119. The mounting plate 56 mounts to the electrical box 23 in conventional manner using a pair of bolts 122 that respectively extend through the transverse keyhole groove 113 and the longitudinal keyhole groove 119 into respective threaded holes 125 of a pair of mounting tabs 128 thereof.

The light assemblies 44 and 47 each include a cord coupling 129 to connect respective electrical cords 131 and 132 extending through respective of the cord mounting holes 65 and 68 of cover plate 50 and a light socket assembly 134 for receiving an externally threaded stem or screw plug 135 dependent from an illuminating globe 136 of a light bulb 137.

The electrical cords 131 and 132 are of conventional construction including electrical conductors which comprise respective insulated electrical wires 139 and 140, insulated electrical wires 142 and 143, and insulated ground wires 145 and 146 contained within respective flexible insulating outer jackets 147 and 148. The electrical cord 131 along with the insulated electrical wires 139, 142, and 145 are longer than the electrical cord 132 along with the insulated electrical wires 140, 143, and 146 for aesthetic purposes. The electrical cords 131 and 132 have respective top ends 149 and 150 which extend through respective of the cord mounting holes 65 and 68 of the cover plate 50. The top ends 149 and 150 are electrically connected to the electrical system 35 of the building structure 32 and mechanically connected to the cover plate 50 using the cord couplings 129. The electrical cords 131 and 132 have respective bottom ends 151 and 152 which are electrically and mechanically connected to respective of the light socket assemblies 134.

More specifically, the insulated electrical wires 139 and 142 are connected to an insulated electrical wire 153 of the electrical system 35 of the building structure 32 that extends through a hole 154 of the electrical box 23 using a screw connector 155. The insulated electrical wires 140 and 143 are connected to a insulated electrical wire 156 of the electrical system 35 that extends through the hole 154 using another screw connector 155. The ground wires 145 and 146 are connected to a ground wire 158 of the electrical system 35 that extends through the hole 154 using a screw 162 that threads into a threaded hole 164 of the electrical box 23. The hanging lighting fixture 20 typically requires an electrician to install due to the necessity of properly connecting together the insulated electrical wires 139, 140, 142, 143, 145, and 146 to the insulated electrical wires 153, 156, and 158 of the electrical system 35.

Each cord coupling 129 includes a tubular gripping body 167 affixed to the cover plate 50 and a tubular gripping nut 170 that threadably engages the gripping body 167 to allow adjustment of respective hanging lengths “HL1” and “HL2” of the light assemblies 44 and 47. Respective unneeded lengths “UL1” and “UL2” of the electrical cords 44 and 47 are stored within the electrical box 23. The domed central area 59 of cover plate 50 allows more of the unneeded lengths “UL1” and “UL2” of the electrical cords 44 and 47 to be stored within the electrical box 23.

The gripping body 167 has a longitudinal bore 171 of sufficient size to closely pass respective of the electrical cords 131 and 132. The gripping body 167 includes an externally threaded upper section 173 that fits through respective of the cord mounting holes 71 and 74 of cover plate 50. An externally threaded middle section 176 is connected to the upper section 173 at a radially enlarged section 179 which define respective upper and lower shoulders 182 and 185. An externally tapered lower section 188 has a plurality of longitudinal slits 191 that define a plurality of flexible gripping fingers 194 having respective movable gripping ends 197. The gripping bodies and nuts 167 and 170 are typically machined from a metal such as aluminum or brass.

The gripping nut 170 has a longitudinal bore 200 with an internally threaded upper half 203 that threadably engages the externally threaded middle section 176 of gripping body 167. A tapered lower half 206 engages the externally tapered lower section 188 of gripping body 167 to radially inwardly compress the gripping ends 197 of the gripping fingers 194 as the gripping nut 170 is threaded onto the gripping body 167 to grip respective of the outer jackets 147 and 148 of the electrical cords 131 and 132 to prevent slippage thereof through the cord couplings 129. The gripping nut 170 is externally longitudinally grooved to facilitate gripping in-hand.

The cord couplings 129 are each mounted to the cover plate 50 extending through respective of the cord mounting holes 65 and 68 using a hardware assembly 209 which includes the lockwasher 89 and one of the hexagonal nuts 92. The upper sections 173 of gripping bodies 167 fit through respective of the cord mounting holes 65 and 68 of cover plate 50 with the lockwashers 89 disposed thereon immediately above the cover plate 50. The hexagonal nuts 92 respectively thread onto the upper sections 173 of gripping bodies 167 tightened against the lockwashers 89 to retain the gripping bodies 167 extending downwardly from the cover plate 50. The cord couplings 129 allow height adjustment of the hanging lighting fixture 20 in conventional manner.

Each light socket assembly 134 comprises a vertical support tube 212, a heat shield 215 of hollowed frusto-conical shape, an electrical socket assembly 218, and a lamp shade assembly 221. The support tube 212 is affixed to the heat shield 215 extending upwardly therefrom. The support tube 212 has a top end 224 where respective of the bottom ends 151 and 152 of electrical cords 131 and 132 enter a longitudinal bore 225 therethrough and an externally threaded bottom end 227 of smaller outer diameter which define a shoulder 230 therebetween and where the electrical cords 131 and 132 exit therefrom. The support tube 212 and heat shield 215 are typically suitably machined from a metal such as steel. Both are typically painted to provide a nice appearance. The socket assembly 218 has ceramic and steel components as described below.

The heat shield 215 includes a circular top wall 233 and a tapered annular outer wall 236. The top wall 233 has a center hole 239 through which the bottom end 227 of the support tube 212 and respective of the electrical cords 131 and 132 pass. The socket assembly 218 is mounted in the heat shield 215.

The electrical socket assembly 218 includes an externally threaded, tubular insulating body 242, a light bulb socket 243 for threadably receiving the light bulb 137 affixed within a longitudinal bore 245 thereof, and a mounting bracket 246 of frusto-triangular shape affixed extending upwardly therefrom. The light bulb socket 243 is electrically connected to respective of the electrical cords 131 and 132. The insulating body 242 has a top end 248 and a bottom end 249 adapted for receiving the screw plug 135 of the light bulb 137 through the longitudinal bore 245 into the light bulb socket 243.

The mounting bracket 246 includes a base leg 250 affixed to the top end 248 of the light bulb socket 243 and a shorter top leg 251 interconnected by a pair of convergent legs 254. The base leg 250 has a center hole 257 to pass the electrical cords 131 and 132 to the light bulb socket 243. The top leg 251 has a center hole 263 through which the bottom end 227 of the support tube 212 and respective of the electrical cords 131 and 132 pass. The insulating body 242 is typically made of ceramic material. The light bulb socket 243 is of conventional design having metal and insulating component parts. The mounting bracket 251 is typically stamped and formed from a metal such as steel and plated for corrosion resistance.

The heat shield 215 and the mounting bracket 246 of socket assembly 218 are mounted to the support tube 212. This is done by the bottom end 227 of support tube 212 extending through the center hole 239 of heat shield 215 and through the center hole 257 of mounting bracket 246. The bottom ends 151 and 152 of electrical cords 131 and 132 pass through respective of the bottom ends 227 of the support tubes 212 and the heat shields 215 and are mechanically connected thereto. A hardware assembly 264 includes the lockwasher 89 and one of the hexagonal nut 92. The lockwasher 89 is disposed on the bottom end 227 of support tube 212 disposed directly below and engaging the mounting bracket 246 and the hexagonal nut 92 threads thereonto tightened against the lockwasher 89 to retain the support tube 212 extending upwardly from the heat shield 215 and the mounting bracket 246 of socket assembly 218.

The lamp shade assembly 221 includes a lamp shade 266 operatively connectable to respective of the bottom ends 151 and 152 of the electrical cords 131 and 132, and an internally threaded support ring 269. The lamp shade 266 comprises a convex annular tapered outer wall 271, a thicker bottom rim 272, and a circular upper end wall 275 with a center hole 278. The insulating body 242 of the socket assembly 218 passes through the center hole 278. The lamp shade 266 is typically made from a tempered glass, plastic, or other suitable transparent or translucent material.

Alternatively, it may be made of opaque plastic or metal such as aluminum or brass and painted to provide a nice appearance.

The lamp shade 266 is retained to the socket assembly 218 with the upper end wall 275 disposed within the heat shield 215 using the support ring 272 which threadably engages the insulating body 242 of the socket assembly 218 disposed below the upper end wall 275. The support ring 269 has a plurality of radial grooves 281 for engaging respective tips 284 of a forked installation tool 287 which facilitates reaching the support ring 269 within the lamp shade 266. The support ring 269 is typically machined from a metal such as brass or steel and plated for corrosion resistance.

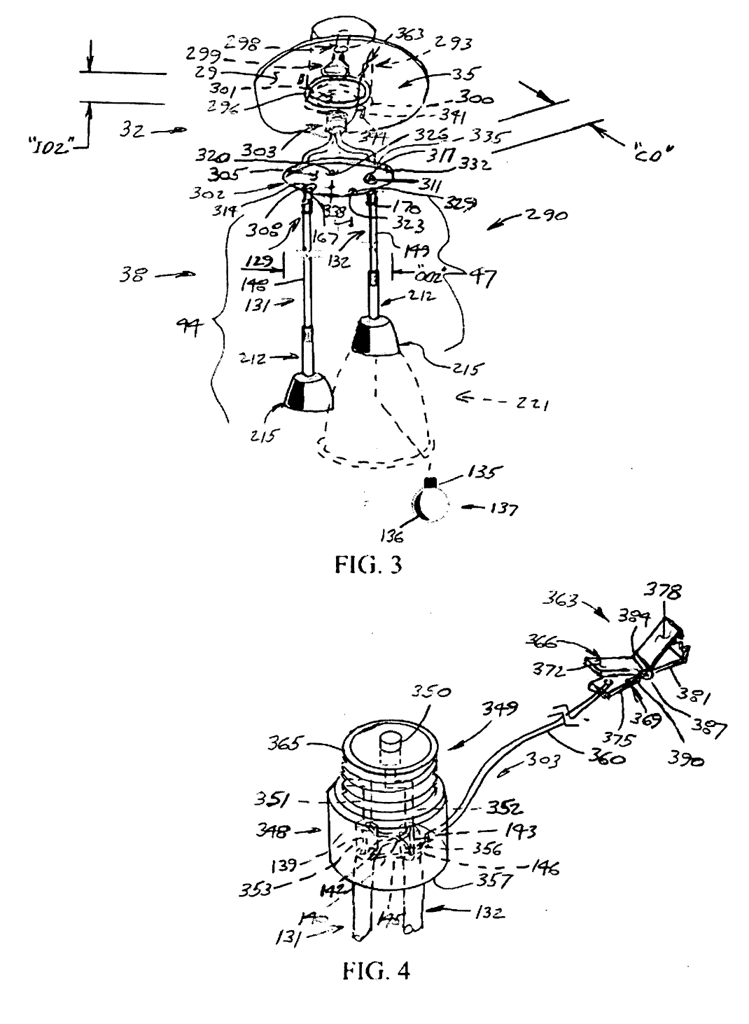

Referring to FIGS. 3 and 4, therein is shown an exemplary ceiling lighting fixture of the present invention in the form of a pendent or hanging lighting fixture, designated generally at 290. The hanging lighting fixture 290 is for mounting to an electrically grounded can or housing 293 of a cylindrical cup-shaped configuration affixed within a hole 296 in the ceiling 29 to the building structure 32. The hanging lighting fixture 290 is connected to the electrical system 35 of the building structure 32 to provide indoors illumination to the room 38 of the building structure 32.

The housing 293 is used for the recessed ceiling light 297 having a light bulb socket 298 mounted therein for threadably receiving a spotlight 299. The light bulb socket 298 is connected to the insulated electrical wire 153 and the insulated electrical wire 156 of the electrical system 35 of the building structure 32 using the screw connectors 155. The ground wire 158 is connected to the housing 293 in the manner described above. The recessed ceiling light 297 has a support ring 300 which connects to the housing 293 to support a circular transparent lens 301 in conventional manner. Both are removed before the ceiling lighting fixture 290 is mounted to the housing 293. The hanging lighting fixture 290 is connected to the electrical system 35 of the building structure 32 through the light bulb socket 298. The housing 293 is about six inches in diameter though other diameters are also used. The hanging lighting fixture 290 allows easy and quick changeover of the recessed ceiling light 297 to the hanging lighting fixture 290 without rewiring.

The hanging lighting fixture 290 includes a domed canopy or cover plate 302, a pair of the light assemblies 44 and 47, and a screw plug 303 that threadably engages the light bulb socket 298 of the recessed ceiling light 297. The cover plate 302 is of circular shape to fit the housing 293 and hole 296 of the circular shape. The cover plate 302 has a domed central area 305 with respective cord mounting holes 308 and 311 disposed therethrough at a pair of flattened cord connecting areas 314 and 317 at which the light assemblies 44 and 47 attach as previously explained. The central area 305 has a pair of ceiling mounting holes 320 and 323 disposed therethrough at respective flattened ceiling connecting areas 326 and 329. The cover plate 302 has an upwardly directed annular outer lip 332 with an annular top edge 335 adapted to engage the ceiling 29. The cover plate 302 mounts to the ceiling 29 and has an outer diameter “OD2” greater than an inner diameter “ID2” of the hole 296 in the ceiling 26 to accommodate the housing 293 to provide a finished look thereto. The outer diameter “OD2” is preferably between about six to eight inches and most preferably two sizes of six and three quarters inches and eight inches to respectively fit housings 293 of two standard sizes. The outer diameter “OD2” allows the ceiling mounting holes 326 and 329 to be disposed at a center diameter “CD” that is larger than the inner diameter “ID2” of the hole 296 in the ceiling 26. The cover plate 302 is made of the materials mentioned above.

The cover plate 302 mounts to the ceiling 29 using a pair of screws 338 that extend through respective of the ceiling mounting holes 326 and 329 thereof disposed radially outwardly of the hole 296 in the ceiling 29 into conventional screw anchors 341 press-fit into respective bores 344 of the ceiling 29.

The light assemblies 44 and 47 each include the cord coupling 129 to connect respective jacketed electrical cords 131 and 132 extending through respective of the cord mounting holes 314 and 317 of cover plate 302 and the light socket assembly 134 for receiving the screw plug 135 of the light bulb 137. The electrical cords 131 and 132 have respective of the insulated electrical wires 139 and 140, the insulated electrical wires 142 and 143, and the ground wires 145 and 146 contained within the outer jackets 147 and 148 all of which are connected to the screw plug 303. The electrical cords 131 and 132 are preferably each generally in the range of about fifty inches in length and may be of differing lengths as shown.

The cord couplings 129 each include the gripping body 167 and the gripping nut 170. The cord couplings 129 are each mounted to the cover plate 302 extending through respective of the cord mounting holes 314 and 317 using the hardware assembly 209 as described above to grip the electrical cords 131 and 132. The electrical cords 131 and 132 of the hanging lighting fixture 290 are preferably about fifty inches in length.

The light socket assemblies 134 each comprise the support tube 212, the heat shield 215, the electrical socket assembly 218, and the lamp shade assembly 221 which are assembled together as described above using the hardware assembly 264, the support ring 272, and the installation tool 287.

The screw plug 303 includes a cylindrical insulating body 348. An electrically conductive outer jacket 349 is affixed about the body 348 of mating externally threaded configuration to threadably engage the light bulb socket 298. An electrically conductive center post 350 extends longitudinally from the body 348 coaxially with the outer jacket 349. The outer jacket 349 and the center post 350 are each electrically connected to the light bulb socket 243 through respective first and second conductor bars 351 and 352. The insulated electrical wires 139 and 140 of the electrical cords 131 and 132 are connected to the first conductor bar 351. The insulated electrical wires 142 and 143 of the electrical cords 131 and 132 are connected to the second conductor bar 352. A pair of bores 353 and 356 extend into a front face 357 of body 348 to closely respectively receive the bottom ends 151 and 152 of the electrical cords 131 and 132. The outer jacket 349, the center post 350, the first and second conductor bars 351 and 352 are all preferably molded together with the body 348 using a suitable plastic material.

The screw plug 303 connects to the housing 293 of the recessed ceiling light 297 for electrical grounding. The light bulb sockets 243 are electrically grounded to the screw plug 303 through the ground wires 145 and 146 of the electrical cords 131 and 132. The ground wires 145 and 146 are connected together within the body 348 to a single ground conductor in the form of a ground wire 360 which extends outwardly from the body 348. The ground wire 360 terminates at an electrically conductive connecting device adapted to connect to the housing 293 in the form of a finger-operable spring clamp 363 for gripping the housing 293 that requires no installation tools.

The spring clamp 363 includes a pair of arm members 366 and 369 having respective finger squeezing sections 372 and 375 and inwardly directed gripping sections 378 and 381 to grip the housing 293 pivotally interconnected at respective middle sections 384 and 387. The arm members 366 and 369 are biased to a closed position using a torsion spring 390 which engages each. The gripping sections 378 and 381 are of a toothed configuration as shown, or of other suitble configuration such as squared-off, pointed, or combinations thereof.

The hanging lighting fixture 290 allows easy and quick changeover of the recessed ceiling light 297 to the hanging lighting fixture 290 without rewiring by screwing said screw plug into the bulb socket and mounting said cover plate to the ceiling. The hanging lighting fixture 290 eliminates the need to have an electrician for installation of the ceiling light 297 since no wires are required to be disconnected and reconnected. A homeowner simply removes the support ring 300 which releases the lens 301. The spotlight 299 is then unscrewed from the light bulb socket 298. The cover plate 302 is used as a template to drill the bores 344 into the ceiling 29 and the screw anchors 341 are tapped into the bores 344. The screw plug 350 of screw plug 303 is threaded into the light bulb socket 298. The cover plate 302 is mounted to the ceiling using the screws 338 which extend through respective of the ceiling mounting holes 326 and 329 and threadably engage respective of the screw anchors 341.

A method of changeover of a recessed ceiling light to a hanging lighting fixture without necessitating rewiring, comprises the steps of: 1) providing a recessed ceiling light which includes an electrically grounded housing attached within a hole in a ceiling to a building structure with an attached light bulb socket electrically connected to a building electrical system for threadably receiving a light bulb; 2) providing a hanging lighting fixture which includes a cover plate of a size and shape sufficient to completely cover the housing and the hole in a mounting position to provide a finished look thereto and adapted to mount to the ceiling using at least a pair of screws that extend through respective ceiling mounting holes thereof disposed radially outwardly of the hole in the ceiling and respective screw anchors, at least one light bulb socket adapted for threadably receiving the light bulb and connected to the cover plate, and a screw plug adapted to threadably engage the light bulb socket which is electrically connected to the light bulb socket through a pair of electrical conductors; 3) drilling at least two bores into the ceiling that align with the ceiling mounting holes of the cover plate in the mounting position; 4) tapping the screw anchors into respective of the bores in the ceiling; 5) threading the screw plug into the light bulb socket; and 6) mounting cover plate to the ceiling by placing the screws through respective of the ceiling mounting holes of the cover plate and screwing them into the screw anchors.

The recessed ceiling light provided may include a support ring which connects to the housing to support a transparent lens, and include a step of removing the support ring to release and remove the transparent lens from the housing of the recessed ceiling light prior to threading the screw plug into the light bulb socket. The hanging lighting fixture provided may have the light bulb separated from the light bulb socket, and include a step of threading the light bulb into the light bulb socket thereof. The recessed ceiling light provided may have the light bulb threadably received in the light bulb socket, and include a step of unthreading the light bulb from the light bulb socket thereof. The hanging lighting fixture provided may include a lamp shade, and include a step of operably connecting the lamp shade to at least one of the light bulb socket and the cover plate. The method may include a step of placing the mounting plate in the mounting position and using it as a template for drilling the bores into the ceiling.

The light bulb socket of the hanging lighting fixture provided may be part of a light assembly which includes an electrical cord having the electrical conductors. A top end thereof extends through a cord mounting hole of the cover plate electrically connected to the screw plug and mechanically connected to the cover plate using an adjustable cord coupling. A bottom end thereof is electrically and mechanically connected to the light bulb socket. A further step comprises adjusting a hanging length of the light assembly using the cord coupling and storing an unneeded length of the electrical cord within the housing.

The screw plug of the hanging lighting fixture provided may be adapted to connect to the housing for electrical grounding and the light bulb socket electrically grounded to the screw plug. The grounding is done using a ground conductor that extends outwardly from the screw plug terminating at an electrically conductive connecting device adapted to connect to the housing. A further step comprises attaching the connecting device to the housing. The connecting device may comprise a finger-operable spring clamp. The step of attaching the connecting device to the housing comprises squeezing and clipping the spring clamp to the housing.

Therefore, the hanging lighting fixture and the method of installation thereof of the present invention solve the aforementioned drawbacks of the prior art devices and methods including: 1) causing minimal or no ceiling damage by requiring only two bores to be drilled in the ceiling eliminating the need for re-spackling and repainting; 2) requiring minimal installation time with no hand-wiring using the screw plug that simply screws into the existing light bulb socket of the recessed ceiling light; 3) the cover plate of the hanging lighting fixture is large enough to hide the previous holes made in the ceiling to mount the recessed ceiling light; 4) remodeling is easily done when desired by the homeowner not requiring the professional to do the work; 5) the hanging lighting fixture is easily replaced if damaged, bums out, or if a different style is desired; and 6) costing no money for professional installation.

Furthermore, the hanging lighting fixture and the method of installation thereof of the present invention solve the aforementioned drawbacks of the prior art devices including: 1) accommodating electrical grounding of the hanging lighting fixture using the spring clamp; 2) having a dependent electrical cord to directly power the hanging lighting fixture; and 3) being of simple design that is reliable and is inexpensive to manufacture and sell.

Many variations to the screw plug of the present invention while staying within the same inventive concept. For example, the hanging lighting fixture, and the screw plug may be adapted for other types of lighting such as wall lighting. Other types of clamps or other devices may be used for grounding which do not require any rewiring for installation such as a small C-clamp.

Whereas this invention is here illustrated and described with reference to embodiments thereof presently contemplated as the best mode of carrying out such invention in actual practice, it is to be understood that various changes may be made in adapting the invention to different embodiments without departing from the broader inventive concepts disclosed herein and comprehended by the claims that follow.

I claim:

1. A hanging lighting fixture for mounting to an electrically grounded housing of a recessed ceiling light affixed within a hole in a ceiling to a building structure with an attached light bulb socket electrically connected to a building electrical system for threadably receiving a light bulb, comprising:
a cover plate adapted to mount to at least one of the ceiling and the housing of a size and shape sufficient to completely cover the housing and the hole to provide a finished look thereto;
at least one light bulb socket adapted for threadably receiving the light bulb and connecting to said cover plate;
a screw plug adapted to threadably engage the light bulb socket of the recessed ceiling light which is electrically connected to said light bulb socket of the hanging lighting fixture through a pair of electrical conductors; and
wherein the hanging lighting fixture allows easy and quick changeover of the recessed ceiling light to the hanging lighting fixture without rewiring by screwing said screw plug into the bulb socket and mounting said cover plate to the at least one of the ceiling and the housing.

2. The hanging lighting fixture according to claim 1, wherein the cover plate mounts to the ceiling using at least a pair of screws that extend through respective ceiling mounting holes thereof disposed radially outwardly of the hole in the ceiling into respective screw anchors press-fit into respective bores of the ceiling.

3. The hanging lighting fixture according to claim 2, wherein the cover plate has a domed central area.

4. The hanging lighting fixture according to claim 3, wherein the ceiling mounting holes are disposed through the domed central area of the cover plate at respective flattened ceiling connecting areas.

5. The hanging lighting fixture according to claim 2, wherein the cover plate has an upwardly directed annular outer lip with a top edge adapted to engage the ceiling.

6. The hanging lighting fixture according to claim 2, wherein the cover plate is circular shape to fit circular housings.

7. The hanging lighting fixture according to claim 6, wherein the cover plate has an outer diameter of between about six to eight inches.

8. The hanging lighting fixture according to claim 7, wherein the cover plate has an outer diameter chosen from the group consisting of about 6¾ inches and about 8 inches to respectively fit housings of two standard sizes.

9. The hanging lighting fixture according to claim 1, wherein each light bulb socket of the hanging lighting fixture is part of a respective light assembly which includes an electrical cord having the electrical conductors which comprise respective insulated electrical wires, said electrical cord having a top end which extends through a cord mounting hole of the cover plate that is electrically connected to the screw plug and mechanically connected to the cover plate using a cord coupling and a bottom end electrically and mechanically connected to said light bulb socket of said hanging lighting fixture.

10. The hanging lighting fixture according to claim 9, wherein each electrical cord includes a flexible insulating outer jacket that encloses the insulated electrical wires.

11. The hanging lighting fixture according to claim 9, wherein each cord coupling includes a gripping body affixed to the cover plate and a gripping nut that threadably engages said gripping body adapted to allow adjustment of a hanging length of the light assembly with an unneeded length of said electrical cord stored within the housing.

12. The hanging lighting fixture according to claim 11, wherein the cover plate has a domed central area with the cord mounting hole disposed therethrough at a flattened cord connecting area which allows more of the unneeded length of the electrical cord to be stored within the housing.

13. The hanging lighting fixture according to claim 9, wherein each light bulb socket of the hanging lighting fixture is part of a respective light assembly which includes a heat shield through which the bottom end of the electrical cord passes that is mechanically connected thereto in which said light bulb socket of the hanging lighting fixture is mounted.

14. The hanging lighting fixture according to claim 13, wherein each heat shield is of hollowed frusto-conical shape having a circular top wall and a tapered annular outer wall.

15. The hanging lighting fixture according to claim 13, wherein each light assembly includes a support tube affixed to the heat shield extending upwardly therefrom through which the bottom end of the electrical cord passes.

16. The hanging lighting fixture according to claim 9, wherein each light assembly includes a lamp shade operatively connectable to the bottom end of the electrical cord.

17. The hanging lighting fixture according to claim 9, wherein each electrical cord is about fifty inches in length.

18. The hanging lighting fixture according to claim 1, wherein the screw plug comprises an insulating body, an electrically conductive outer jacket that is of mating externally threaded configuration to the light bulb socket of the recessed ceiling light affixed about said body, and an electrically conductive center post that extends longitudinally from said body coaxially with said outer jacket, each being electrically connected to the light bulb socket of the recessed ceiling light through respective of the electrical conductors.

19. The hanging lighting fixture according to claim 18, wherein the body of the screw plug is cylindrical.

20. The hanging lighting fixture according to claim 18, wherein the outer jacket, the center post, and a part of each electrical conductor are integrally molded into the body.

21. The hanging lighting fixture according to claim 18, wherein the part of each electrical conductor integrally molded into the body comprise separate conductor bars that connect between the electrical conductors and respective of the outer jacket and the center post.

22. The hanging lighting fixture according to claim 18, wherein a bore extends into the body of the screw plug adapted to receive each pair of the electrical conductors.

23. The hanging lighting fixture according to claim 1, wherein the screw plug is adapted to connect to the housing of the recessed ceiling light for electrical grounding and the light bulb socket of the hanging lighting fixture is electrically grounded to said screw plug through a ground conductor.

24. The hanging lighting fixture according to claim 23, wherein the ground conductor has a lower end connected to the light bulb socket of the hanging lighting fixture and an upper end that extends outwardly from the screw plug terminating at an electrically conductive connecting device adapted to connect to the housing.

25. The hanging lighting fixture according to claim 24, wherein the connecting device comprises a clamp adapted for gripping the housing.

26. The hanging lighting fixture according to claim 25, wherein the clamp comprises a finger-operable spring clamp that requires no installation tools.

27. The hanging lighting fixture according to claim 26, wherein the spring clamp comprises a pair of arm members having respective finger squeezing sections and inwardly directed gripping sections adapted to grip the housing pivotally interconnected at respective middle sections, said arm members being biased to a closed position using a spring which engages each.

28. The hanging lighting fixture according to claim 27, wherein the gripping sections are of a configuration chosen from the group consisting of toothed, squared-off, pointed, and combinations thereof.

29. A hanging lighting fixture for mounting to an electrically grounded housing of a recessed ceiling light affixed within a hole in a ceiling to a building structure with an attached light bulb socket electrically connected to a building electrical system for threadably receiving a light bulb, comprising:
a cover plate adapted to mount to at least one of the ceiling and the housing of a size and shape sufficient to completely cover the housing and the hole to provide a finished look thereto;
a light assembly which includes at least one light bulb socket adapted for threadably receiving the light bulb and connecting to said cover plate, an electrical cord having a pair of insulated electrical wires, said electrical cord having a top end which extends through a cord mounting hole of said cover plate that is electrically connected to said screw plug and mechanically connected to said cover plate using a cord coupling and a bottom end electrically and mechanically connected to said light bulb socket of the hanging lighting fixture, a heat shield through which said bottom end of said electrical cord passes that is mechanically connected thereto in which said light bulb socket of the hanging lighting fixture is mounted, and a lamp shade operatively connectable to the bottom end of said electrical cord;
a screw plug adapted to threadably engage the light bulb socket of the recessed ceiling light which is electrically connected to said light bulb socket of the hanging lighting fixture through said insulated electrical wires; and
wherein said cover plate mounts to the ceiling using at least a pair of screws that extend through respective ceiling mounting holes thereof disposed radially outwardly of the hole in the ceiling into respective screw anchors press-fit into respective bores of the ceiling, the hanging lighting fixture allowing easy and quick changeover of the recessed ceiling light to the hanging lighting fixture without rewiring by screwing said screw plug into the bulb socket and mounting said cover plate to the housing.

30. The hanging lighting fixture according to claim 29, wherein each cord coupling includes a gripping body affixed to said cover plate and a gripping nut that threadably engages said gripping body adapted to allow adjustment of a hanging length of the light assembly with an unneeded length of said electrical cord stored within the housing.

31. The hanging lighting fixture according to claim 30, wherein the cover plate is circular shape to fit circular housings having an upwardly directed annular outer lip with a top edge adapted to engage the ceiling, and an outer diameter of between about six to eight inches.

32. The hanging lighting fixture according to claim 29, wherein the screw plug comprises an insulating body, an electrically conductive outer jacket of mating externally threaded configuration to the light bulb socket of the recessed ceiling light affixed about said body, and an electrically conductive center post that extends longitudinally from said body coaxially with said outer jacket, each being electrically connected to the hanging lighting fixture through respective electrical conductors, said screw plug being adapted to threadably engage the light bulb socket of the recessed ceiling light, and said screw plug is adapted to connect to the housing of the recessed ceiling light for electrical grounding and the light bulb socket of the hanging lighting fixture is electrically grounded to said screw plug through a ground conductor.

33. The hanging lighting fixture according to claim 32, wherein the ground conductor has a lower end connected to the light bulb socket of the hanging lighting fixture and an upper end that extends outwardly from the screw plug terminating at an electrically conductive connecting device adapted to connect to the housing.

34. The hanging lighting fixture according to claim 33, wherein the connecting device comprises a clamp adapted for gripping the housing.

35. The hanging lighting fixture according to claim 34, wherein the clamp comprises a finger-operable spring clamp that requires no installation tools.

36. The hanging lighting fixture according to claim 35, wherein the spring clamp comprises a pair of arm members having respective finger squeezing sections and inwardly directed gripping sections adapted to grip the housing pivotally interconnected at respective middle sections, said arm members being biased to a closed position using a spring which engages each.

37. The hanging lighting fixture according to claim 36, wherein the gripping sections are of a configuration chosen from the group consisting of toothed, squared-off, pointed, and combinations thereof.

38. The hanging lighting fixture according to claim 29, wherein the outer jacket, the center post, and a part of each electrical conductor are integrally molded into the body, said part of each electrical conductor integrally molded into said body comprising separate conductor bars that connect between said electrical conductors and respective of said outer jacket and the center post, a bore extends into said body adapted to receive each pair of said electrical conductors, and said body is cylindrical.

39. A screw plug for electrically powering a hanging lighting fixture changed over from a recessed ceiling light without rewiring of a type that has an electrically grounded housing affixed within a hole in a ceiling to a building structure with an attached light bulb socket electrically connected to a building electrical system for threadably receiving a light bulb, the screw plug comprising:
an insulating body, an electrically conductive outer jacket of mating externally threaded configuration to the light bulb socket of the recessed ceiling light affixed about said body, and an electrically conductive center post that extends longitudinally from said body coaxially with said outer jacket, each being electrically connected to the hanging lighting fixture through respective electrical conductors, said screw plug being adapted to threadably engage the light bulb socket of the recessed ceiling light; and
wherein the screw plug is adapted to connect to the housing of the recessed ceiling light for electrical grounding and the hanging lighting fixture is electrically grounded to the screw plug through a ground conductor.

40. The screw plug according to claim 39, wherein the ground conductor has a lower end connected to the light bulb socket of the hanging lighting fixture and an upper end that extends outwardly from the screw plug terminating at an electrically conductive connecting device adapted to connect to the housing.

41. The screw plug according to claim 40, wherein the connecting device comprises a clamp adapted for gripping the housing.

42. The screw plug according to claim 41, wherein the clamp comprises a finger-operable spring clamp that requires no installation tools.

43. The hanging lighting fixture according to claim 42, wherein the spring clamp comprises a pair of arm members having respective finger squeezing sections and inwardly directed gripping sections adapted to grip the housing pivotally interconnected at respective middle sections, said arm members being biased to a closed position using a spring which engages each.

44. The screw plug according to claim 43, wherein the gripping sections are of a configuration chosen from the group consisting of toothed, squared-off, pointed, and combinations thereof.

45. The screw plug according to claim 39, wherein the outer jacket, the center post, and a part of each electrical conductor are integrally molded into the body, said part of each electrical conductor integrally molded into said body comprising separate conductor bars that connect between said electrical conductors and respective of said outer jacket and the center post, a bore extends into said body adapted to receive each pair of said electrical conductors, and said body is cylindrical.

46. A method of changeover of a recessed ceiling light to a hanging lighting fixture without necessitating rewiring, comprising the steps of:
providing a recessed ceiling light which includes an electrically grounded housing attached within a hole in a ceiling to a building structure with an attached light bulb socket electrically connected to a building electrical system for threadably receiving a light bulb;
providing a hanging lighting fixture which includes a cover plate of a size and shape sufficient to completely cover the housing and the hole in a mounting position to provide a finished look thereto and adapted to mount to the ceiling using at least a pair of screws that extend through respective ceiling mounting holes thereof disposed radially outwardly of the hole in the ceiling and respective screw anchors, at least one light bulb socket adapted for threadably receiving the light bulb and connected to the cover plate, and a screw plug adapted to threadably engage the light bulb socket of the recessed ceiling light which is electrically connected to the light bulb socket of the hanging lighting fixture through a pair of electrical conductors;
drilling at least two bores into the ceiling that align with the ceiling mounting holes of the cover plate in the mounting position;
tapping the screw anchors into respective of the bores in the ceiling;
threading the screw plug into the light bulb socket; and
mounting cover plate to the ceiling by placing the screws through respective of the ceiling mounting holes of the cover plate and screwing them into the screw anchors.

47. The method according to claim 46, wherein the recessed ceiling light provided further includes a support ring which connects to the housing to support a transparent lens, and further comprising a step of removing the support ring to release and remove the transparent lens from the housing of the recessed ceiling light prior to threading the screw plug into the light bulb socket.

48. The method according to claim 46, wherein the hanging lighting fixture provided has the light bulb separated from the light bulb socket thereof, and further comprising a step of threading the light bulb into the light bulb socket thereof.

49. The method according to claim 46, wherein the recessed ceiling light provided has the light bulb threadably received in the light bulb socket thereof, and further comprising a step of unthreading the light bulb from the light bulb socket thereof.

50. The method according to claim 46, wherein the hanging lighting fixture provided further includes a lamp shade, and further comprising a step of operably connecting the lamp shade to at least one light bulb socket and the cover plate thereof.

51. The method according to claim 46, further comprising a step of placing the mounting plate in the mounting position and using it as a template for drilling the bores into the ceiling.

52. The method according to claim 46, wherein the light bulb socket of the hanging lighting fixture provided is part of a light assembly which includes an electrical cord having the electrical conductors with a top end that extends through a cord mounting hole of the cover plate electrically connected to the screw plug and mechanically connected to the cover plate using an adjustable cord coupling and a bottom end electrically and mechanically connected to the light bulb socket thereof, and further comprising a step of adjusting a hanging length of the light assembly using the cord coupling and storing an unneeded length of the electrical cord within the housing.

53. The method according to claim 46, wherein the screw plug of the hanging lighting fixture provided is adapted to connect to the housing for electrical grounding and the light bulb socket thereof is electrically grounded to the screw plug using a ground conductor having lower end connected to the light bulb socket of the hanging lighting fixture and an upper end that extends outwardly from the screw plug terminating at an electrically conductive connecting device adapted to connect to the housing.

54. The method according to claim 53, wherein the connecting device of the hanging lighting fixture provided comprises a finger-operable spring clamp, and the step of attaching the connecting device to the housing comprises squeezing and clipping the spring clamp to the housing.

55. A method of changeover of a recessed ceiling light to a hanging lighting fixture without necessitating rewiring, comprising the steps of:
providing a recessed ceiling light which includes an electrically grounded housing attached within a hole in a ceiling to a building structure with an attached light bulb socket electrically connected to a building electrical system for threadably receiving a light bulb, and a support ring which connects to the housing to support a transparent lens;
providing a hanging lighting fixture which includes a cover plate of a size and shape sufficient to completely cover the housing and the hole in a mounting position to provide a finished look thereto and adapted to mount to the ceiling using at least a pair of screws that extend through respective ceiling mounting holes thereof disposed radially outwardly of the hole in the ceiling and respective screw anchors, a light assembly which includes at least one light bulb socket adapted for threadably receiving the light bulb and connected to the cover plate, a screw plug adapted to threadably engage the light bulb socket of the recessed ceiling light which is electrically connected to the light bulb socket of the hanging lighting fixture through an electrical cord having a pair of electrical conductors with a top end that extends through a cord mounting hole of the cover plate electrically connected to the screw plug and mechanically connected to the cover plate using an adjustable cord coupling and a bottom end electrically and mechanically connected to the light bulb socket thereof, and a lamp shade;
removing the support ring to release and remove the transparent lens from the housing of the recessed ceiling light;
drilling at least two bores into the ceiling that align with the ceiling mounting holes of the cover plate in the mounting position;
tapping the screw anchors into respective of the bores in the ceiling;
threading the screw plug into the light bulb socket;
operably connecting the lamp shade to the bottom end of the electrical cord;
mounting cover plate to the ceiling by placing the screws through respective of the ceiling mounting holes of the cover plate and screwing them into the screw anchors; and
adjusting a hanging length of the light assembly using the cord coupling and storing an unneeded length of the electrical cord within the housing.

56. The method according to claim 55, wherein the screw plug of the hanging lighting fixture provided is adapted to connect to the housing for electrical grounding and the light bulb socket of the hanging lighting fixture is electrically grounded to the screw plug using a ground conductor that extends through the electrical cord and outwardly from the screw plug terminating at an electrically conductive, finger-operable spring clamp adapted to connect to the housing, and further comprising a step of attaching the connecting device to the housing by squeezing and clipping the spring clamp to the housing.

57. The method according to claim 55, wherein the recessed ceiling light provided has the light bulb threadably received in the light bulb socket thereof, the hanging lighting fixture provided has the light bulb separated from the light bulb socket thereof, and further comprising steps of unthreading the light bulb from the light bulb socket of the recessed ceiling light, placing the mounting plate in the mounting position and using it as a template for drilling the bores into the ceiling, and threading the light bulb into the light bulb socket of the hanging lighting fixture.
